(19) United States
(12) Patent Application Publication
(10) Pub. No.: US 2025/0112525 A1
(43) Pub. Date: Apr. 3, 2025

(54) ENHANCED COOLING SYSTEMS FOR ELECTROMAGNETIC COMPONENTS

(71) Applicant: DRS Naval Power Systems, Inc., Milwaukee, WI (US)

(72) Inventors: Edgar S. Thaxton, Groton, MA (US); Calvin H. Corey, Scituate, MA (US); Gene Castles, Lake Hopatcong, NJ (US)

(73) Assignee: DRS Naval Power Systems, Inc., Milwaukee, WI (US)

(21) Appl. No.: 18/900,272

(22) Filed: Sep. 27, 2024

Related U.S. Application Data
(60) Provisional application No. 63/586,923, filed on Sep. 29, 2023.

(51) Int. Cl. H02K 9/22; H02K 9/10

(52) U.S. Cl. CPC H02K 9/223; H02K 9/10

(57) ABSTRACT

Various embodiments of the present disclosure include an apparatus and systems including a cooling tube including a proximal end having a first opening and a distal end having a second opening. The cooling tube includes an intermediate portion extending between the proximal end and the distal end. The apparatus includes an interface component disposed on an exterior interface of the intermediate portion and at least partially encapsulating the cooling tube, the interface component composed of an electrically insulating and thermally conductive material. The interface component is in abutting contact with one or more heat conducting or heat generating elements of an electromechanical device.

### CROSS-REFERENCES TO RELATED APPLICATIONS

This application claims priority to U.S. Provisional Patent Application No. 63/586,923, filed on Sep. 29, 2023, entitled “Enhanced Cooling Systems for Electromagnetic Components,” the disclosure of which is hereby incorporated by reference in its entirety for all purposes.

### BACKGROUND OF THE INVENTION

In various high-performance motors, cooling tubes may be used in stator slots to cool windings, coils, and other components. Cooling tubes are typically a more aggressive cooling mechanism than conventional air-cooling techniques.

Despite the progress made in the area of high-performance motors, there is a need in the art for improved methods and systems for cooling components of high-performance motors.

### SUMMARY OF THE INVENTION

The present disclosure generally relates to an electrically insulating and thermally conductive interface component applied to cooling tubes in cooling systems. More particularly, embodiments of the present invention provide systems that use interface material(s) to enhance the thermal interface between electrically conductive cooling system components, electrical windings, and electrical grade steel or alloy cores. Embodiments of the present invention are applicable to a wide variety of electrical power systems.

Various embodiments of the present disclosure describe an interface component characterized by a high thermal conductivity and a low electrical conductivity. In various embodiments of the present disclosure, an interface component configuration comprising an electrically insulating material surrounds a cylindrical cooling tube to provide electrical insulation for the cooling tube. In some embodiments, the interface component provides contact on all sides of the cooling tube. In other embodiments, the cooling tubes are otherwise encapsulated in the interface component in a manner that is electrically insulating. The interface component may be thermally conductive but non-electrically conductive ceramics such as Boron-Nitride, Silicon-Carbide, or the like.

Numerous benefits are achieved by way of the present disclosure over conventional techniques. Embodiments of the present invention optimize cooling by electrically insulating cooling tubes in machinery and increasing the thermal conductivity of the cooling tubes by providing an interface component according to various techniques described herein. These and other embodiments of the disclosure, along with many of its advantages and features, are described in more detail in conjunction with the text below and corresponding figures.

### BRIEF DESCRIPTION OF THE DRAWINGS

FIG. 1A illustrates a cross-section view of a motor stator including an interface component in accordance with one embodiment of the present disclosure.

FIG. 1B illustrates a perspective view of an interface component in accordance with one embodiment of the present disclosure.

FIG. 2 illustrates a cross-section view of a motor stator including an interface component sized to fit within a slot using a shim in accordance with one embodiment of the present disclosure.

FIG. 3 illustrates a cross-section view of a motor stator including an interface component sized to fit within a slot in accordance with one embodiment of the present disclosure.

FIG. 4 illustrates a cross-section view of a motor stator including an interface component that is deposited in place within a slot in accordance with one embodiment of the present disclosure.

FIG. 5A illustrates a “slotless” arrangement without laminations in accordance with various embodiments of the present disclosure.

FIG. 5B illustrates a “semi-slotless” arrangement with a partially laminated structure in accordance with various embodiments of the present disclosure.

FIG. 6A illustrates a cross-section view of an interface component applied between a cold plate and electrical conductors in accordance with various embodiments of the present disclosure.

FIG. 6B illustrates a cross-section view of an interface component applied between a cold plate and a magnetically permeable core in accordance with various embodiments of the present disclosure.

FIG. 6C illustrates a cross-section view of an interface component applied between a cold plate and electrical conductors and between a cold plate and a magnetically permeable core in accordance with various embodiments of the present disclosure.

FIG. 7 illustrates an exemplary application of the enhanced cooling embodiments described herein in accordance with various embodiments of the present disclosure.

### DETAILED DESCRIPTION OF THE INVENTION

The present disclosure generally relates to an electrically insulating and thermally conductive interface component applied to cooling tubes in cooling systems. More particularly, embodiments of the present invention provide systems that use interface material(s) to enhance the thermal interface between electrically conductive cooling system components, electrical windings, and electrical grade steel or alloy cores. Embodiments of the present invention are applicable to a wide variety of electrical power systems.

The enhanced cooling system for electromagnetic components described herein greatly improves the thermal performance (e.g., power density) of electromagnetic components including but not limited to motors, generators, transformers and inductors. Advanced materials such as Boron-Nitride provide high thermal conductivity relative to conventional electrical insulating materials and act as an electrical insulator. Therefore, various embodiments of the present disclosure use Boron-Nitride as an enhanced thermal interface between electrically conductive cooling system components, electrical windings and electrical grade steel or alloy cores. The advanced material interface may replace conventional electrical insulation materials that are historically poor thermal conductors thereby greatly increasing the thermal conductivity of cooling system circuits. Various embodiments described herein improve the thermal conductivity by at least 30° C. at the operating current. Accordingly, regardless of the source of the heat, the interface component draws heat from the system for cooling.

Conventional cooling tubes may be formed in generally square shapes along the length of the cooling tubes. The amount of inspection for cooling tubes formed in this manner is time consuming and costly. The forming process is relatively complicated and inaccurate. Cooling tubes that are not fully square do not make adequate thermal contact on all sides, leading to reduced thermal conductivity. Any electrical conductance through the cooling tubes degrades the performance of the cooling tubes. In some conventional techniques, an electrically insulating slot liner is used between the cooling tube and the coils, thereby further reducing direct contact for cooling and creating a thermal barrier, which adversely impacts cooling performance.

The enhanced cooling system for electromagnetic components described herein contrasts with typical electromagnetic cooling schemes that include forced or free convection air cooling, liquid cooling via integral back iron cold plate or cooling tubes, or direct cooled conductors (e.g., non-electrically conductive fluid within or surrounding coil conductors). This is also in contrast with less standard cooling arrangements where a cooling tube is preferentially placed within the electromagnetic components such that the cooling tube is in close proximity to the heat sources (e.g. electrical conductors) and isolated with electrically insulating materials that exhibit poor thermal conductivity (e.g., plastic, aramid, polyimide, or woven fiber products). The enhanced cooling system has been produced in a Boron-Nitride interface component configuration, demonstrating performance improvement on multiple statorettes that have demonstrated thermal performance improvements. Other embodiments of the present disclosure may include other homogenous or composite materials that provide high thermal conductivity relative to conventional electrical insulating materials while acting as an electrical insulator. Various manufacturing techniques such as machining, casting, 3D printing, and flame spray deposition may be employed.

According to various embodiments described herein, embodiments of the present invention are able to replace or augment existing conventional insulation materials such as “slot liners,” “glass tape,” “MICA tape,” etc., with non-conventional materials that exhibit low thermal conductivity and high electric resistivity (e.g., Boron-Nitride, Boron-Carbide, diamond, etc.). For example, these thermal conductivity and high electric resistivity materials minimize insulation thickness and maximize coil conductor cross-sectional area to minimize Joule Losses in the machine such that Joule Losses ∝1/Copper Cross Sectional Area. In one exemplary embodiment, the thermally conductive and high electric resistivity material is Boron-Nitride having an electrical volume resistivity of greater than 10¹² ohm cm, a dielectric strength between 10 kV/mm and 230 kV/mm, and a thermal conductivity between 10 W/(m-K) and 230 W/(m-K). In contrast, convention insulation materials have thermal conductivities ranging from 0.1 W/mK to 1.0 W/mK.

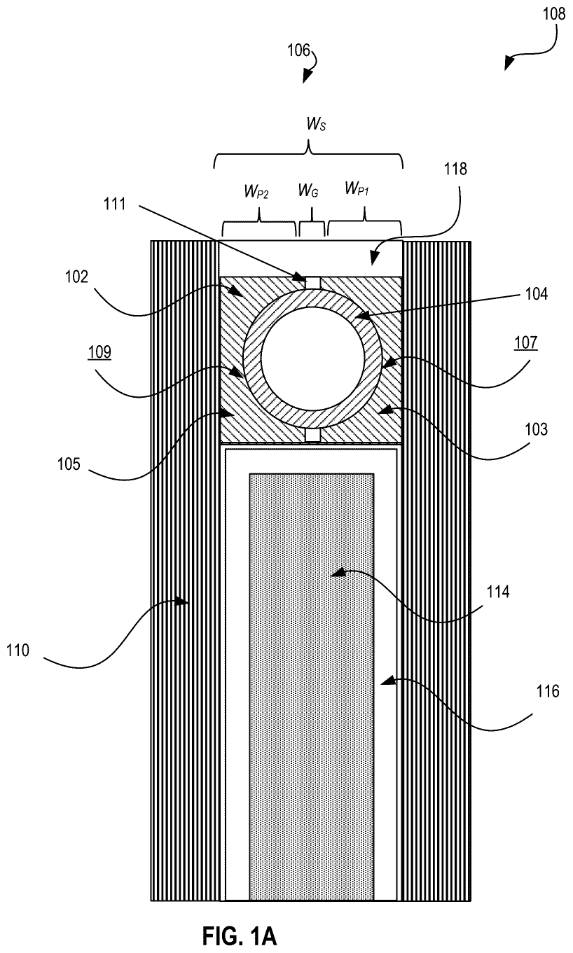

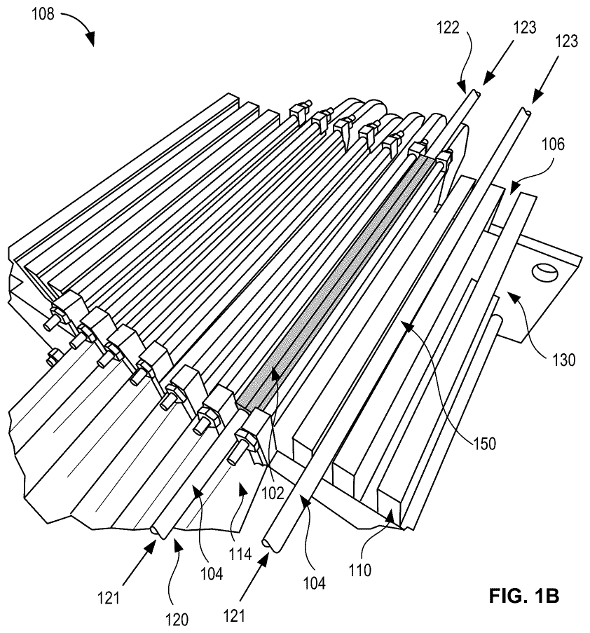

FIG. 1A illustrates a cross-section view of a cross-section view of a motor stator 108 including an interface component 102 in accordance with one embodiment of the present disclosure. According to various embodiments, the interface component 102 may include an electrically insulating and thermally conductive material such as Boron-Nitride, Boron-Carbide, diamond, Silicon-Carbide, or the like, or any combination thereof. In exemplary embodiments, the interface component 102 predominantly includes Boron-Nitride. FIG. 1A illustrates one application of the advanced interface material including Boron-Nitride. Boron-Nitride has favorable thermal conductivity to help expel heat from the motor stator. Boron-Nitride may be used at elevated temperatures, for example, less than or equal to 800° C.

According to various embodiments, the interface component 102 may be in abutting contact with one or more heat conducting or heat generating elements of the motor stator 108 or other electromechanical device. Such heat conducting or heat generating elements may include, for example, the heat source 114 or a stack of laminations 110. According to various embodiments, an interface component 102 may include a plurality of portions or the interface component 102 may be a single unitary piece. An interface component 102 may include a first portion 103 and a second portion 105 where the first portion 103 and the second portion 105 are mirror images of each other. In various embodiments, the interface component 102 includes a plurality of portions such as at least three portions, at least four portions, etc. The first portion 103 may include a first interface 107 and the second portion 105 may include a second interface 109. The first interface 107 and the second interface 109 may be mirror images of one another, according to at least some embodiments. As shown in FIG. 1A, the first interface 107 and the second interface 109 are curved such that the first interface 107 and the second interface 109 contact at least a portion of the cooling tube 104. For example, the first portion 103 has a width, W_{P1}, and the second portion 105 has a width, W_{P2}, and a gap 111 between the first portion 103 and the second portion 105 has a width, W_{G}. W_{P1} may be greater than, less than, or equal to W_{P2} according to various embodiments. A slot 106 of a motor stator 108 including the first portion 103 and the second portion 105 may be characterized as having a width, W_{S}, where W_{S}=W_{P1}, +W_{P2}+W_{G}. The gap 111 ensures that there is sufficient physical contact between the cooling tube 104 and the first portion 103 and the second portion 105 of the interface component 102. The gap 111 ensures that the interface component 102 is sufficiently wedged against the slot 106 to provide adequate thermal contact. In one exemplary embodiment, if the motor stator 108 is then Vacuum Pressure Impregnated (VPI), the gap 111 would be filled with resin during the VPI process performed on a completed motor stator assembly.

In some embodiments, the first interface 107 and the second interface 109 contact an entire exterior of the cooling tube 104 and the slot 106 has a width, W_{S}, where W_{S}=W_{P1}, +W_{P2}. For example, a length of the first interface 107 in addition to a length of the second interface 109 is equal to the circumference of the cooling tube 104 in at least some embodiments. The cooling tube 104 may include a proximal end (e.g., in a direction out of the page) having a first opening and a distal end (e.g., in a direction into the page) having a second opening. The cooling tube 104 may include an intermediate portion that extends between the proximal end and the distal end.

According to various embodiments, and as shown in FIG. 1A, the first interface 107 and the second interface 109 are curved such that the first interface 107 and the second interface 109 contact at least a portion of the cooling tube 104. Cooling tubes as used throughout the present disclosure may include stainless steel. The cooling tube 104 may include electrically conductive materials such as Stainless Steel, Steel, Copper, Copper-Nickel, etc., or any combination thereof. In the embodiment illustrated in FIG. 1A, cooling fluid flows into the plane of the figure and through the cooling tube 104.

In this embodiment, a typical electric motor arrangement is represented. The motor stator 108 includes a stack of laminations 110 on each side of the slot 106. The electrical current conducted through the heat source 114 (e.g., coils or the like) produces flux in the stack of laminations 110 that interact with the rotor (e.g., the rotating portion of electric machine) resulting in torque on the rotor (not shown). To remove heat produced in the motor stator 108, a cooling tube 104 may be included and is electrically isolated from the stack of laminations 110 and the heat source 114. In various embodiments, the first portion 103 and the second portion 105 of the interface component 102 are disposed between an insulator 116 disposed on a heat source 114 and a top-stick 118. The top-stick 118 is a mechanical feature for retaining the various components in the slot 106 (e.g., the cooling tube 104, the first portion 103 and the second portion 105 of the interface components, etc.). According to some embodiments, there are grooves (not shown) in the stack of laminations 110 that corresponding grooves (not shown) of the top-stick 118 slide into during assembly. The high electrical resistivity of Boron-Nitride allows the cooling assembly to be placed in the slot 106 (e.g., such as a stator slot) with the heat source 114 without adding supplementary electrical insulating material. Supplementary electrical insulating material may reduce the overall thermal conductivity of the cooling system. Boron-Nitride is available in different grades and is easily machinable. This allows for different geometries of either slot width and/or tube sizes. Any length or number of slots may be used. The cooling tube 104 may be made of any material that is compatible with the cooling medium.

In various embodiments, the interface component 102 may be used in non-motor generator applications such as for stationary electromagnetic components. In particular, for transformers having back iron pieces that are kept cool, the interface component 102 may be applied to a cold plate and the transformer laminations to improve thermal conductivity.

FIG. 1B illustrates a perspective view of an interface component in accordance with one embodiment of the present disclosure. FIG. 1B illustrates a motor stator 108 having a stator 130 with a plurality of slots. Each slot 106 may include an interface component 102 encapsulating a cooling tube 104. According to various embodiments, the interface component 102 may include an electrically insulating and thermally conductive material such as Boron-Nitride, Boron-Carbide, diamond, Silicon-Carbide, or the like, or any combination thereof. In exemplary embodiments, the interface component 102 predominantly includes Boron-Nitride. FIG. 1B illustrates one application of the advanced interface material including Boron-Nitride. Boron-Nitride has favorable thermal conductivity to help expel heat from the motor stator. Boron-Nitride may be used at elevated temperatures, for example, less than or equal to 800° C.

According to various embodiments, the interface component 102 may be in abutting contact with one or more heat conducting or heat generating elements of the motor stator 108 or other electromechanical device. Such heat conducting or heat generating elements may include, for example, the heat source 114 or a stack of laminations 110. According to various embodiments, an interface component 102 may include a plurality of portions or the interface component 102 may be a single unitary piece.

The cooling tube 104 may include a proximal end 120 having a first opening 121 and a distal end 122 having a second opening 123. The cooling tube 104 may include an intermediate portion 150 (encapsulated by the interface component 102) that extends between the proximal end 120 and the distal end 122. Cooling tubes as used throughout the present disclosure may include stainless steel. The cooling tube 104 may include electrically conductive materials such as Stainless Steel, Steel, Copper, Copper-Nickel, etc., or any combination thereof. In the embodiment illustrated in FIG. 1B, cooling fluid flows between the first opening 121 and the second opening 123 through the cooling tube 104.

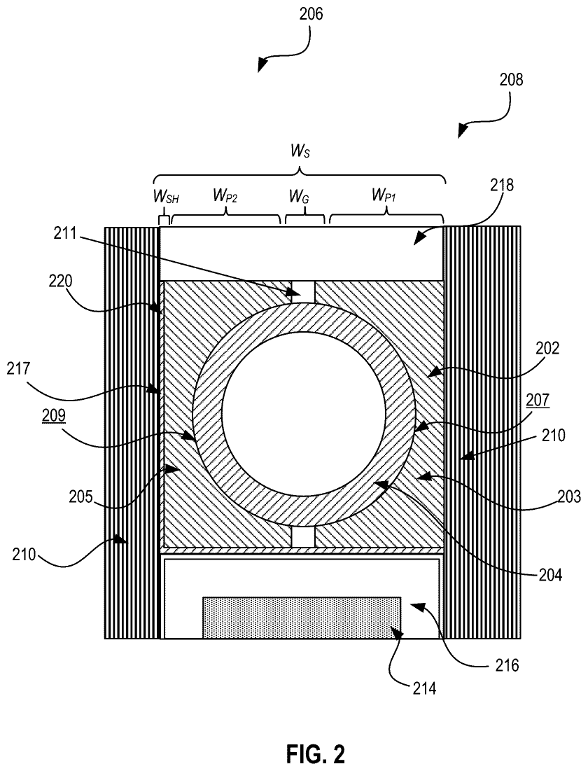

FIG. 2 illustrates a cross-section view of a motor stator 208 including an interface component 202 sized to fit within a slot 206 using a shim 220 in accordance with one embodiment of the present disclosure. According to various embodiments, the interface component 202 may include an electrically insulating and thermally conductive material such as Boron-Nitride, Boron-Carbide, diamond, Silicon-Carbide, or the like, or any combination thereof. In exemplary embodiments, the interface component 202 predominantly includes Boron-Nitride. FIG. 2 illustrates one application of the advanced interface material including Boron-Nitride. Boron-Nitride has favorable thermal conductivity to help expel heat from the motor stator. Boron-Nitride may be used at elevated temperatures, for example, less than or equal to 800° C. The high electrical resistivity of Boron-Nitride allows the cooling assembly to be placed in the slot 206 (e.g., such as a stator slot) with the heat source 214 without adding supplementary electrical insulating material. Supplementary electrical insulating material may reduce the overall thermal conductivity of the cooling system. Boron-Nitride is available in different grades and is easily machinable. This allows for different geometries of either slot width and/or tube sizes. Any length or number of slots may be used. The cooling tube 204 may be made of any material that is compatible with the cooling medium.

According to various embodiments, the interface component 202 may include a plurality of portions or the interface component 202 may be a single unitary piece. The interface component 202 may include a first portion 203 and a second portion 205 where the first portion 203 and the second portion 205 are mirror images of one another. In various embodiments, the interface component 202 includes a plurality of portions such as at least three portions, at least four portions, etc. The first portion 203 may include a first interface 207 and the second portion 205 may include a second interface 209. The first interface 207 and the second interface 209 may be mirror images of one another, according to at least some embodiments. As shown in FIG. 2, the first interface 207 and the second interface 209 are curved such that the first interface 207 and the second interface 209 contact at least a portion of the cooling tube 204.

According to some embodiments, the interface component 202 is undersized such that there is a clearance fit within the slot 206. A shim 220 may be used to snug fit an interface component 202 encapsulating a cooling tube 204 in various geometries, such as shown in FIG. 2. The shim 220 may be used to wedge in between the cooling assembly (e.g., the interface component 202 and the cooling tube 204) and a wall 217 of the slot 206, as shown in FIG. 2. The shim 220 may include any combination of materials. In one exemplary embodiment, G-11 glass epoxy laminate may be used for the shim 220 as it does not significantly reduce the thermal performance.

In this embodiment, the first portion 203 has a width, W_{P1}, and the second portion 205 has a width, W_{P2}, and a gap 211 between the first portion 203 and the second portion 205 has a width, W_{G}. The gap 211 ensures that there is sufficient physical contact between the cooling tube 204 and the first portion 203 and the second portion 205 of the interface component 202. The gap 211 ensures that the interface component 202 is sufficiently wedged against the slot 206 for providing adequate thermal contact. A slot 206 of the motor stator 208 including the first portion 203 and the second portion 205 may be characterized as having a width, W_{S}. In this embodiment, W_{P1} is not equal to W_{P2} and W_{S}: W_{P1}+W_{P2}+W_{G}. Accordingly, a shim 220 may be provided to fit the interface component 202 within the slot 206. The shim 220 may have a width, W_{SH}, that supplements the width of the first portion 203 and the second portion 205 such that W_{S} W_{P1}+W_{P2}+W_{G}+W_{SH}. In various embodiments, one or more shims may be used, for example, a first shim adjacent to the first portion 203 and a second shim adjacent to the second portion 205.

According to various embodiments, and as shown in FIG. 2, the first interface 207 and the second interface 209 are curved such that the first interface 207 and the second interface 209 contact at least a portion of the cooling tube 204. Cooling tubes as used throughout the present disclosure may include stainless steel. A cooling tube 204 may include electrically conductive materials such as Stainless Steel, Steel, Copper, Copper-Nickel, etc., or any combination thereof. In the embodiment illustrated in FIG. 2, cooling fluid flows into the plane of the figure and through the cooling tube 204.

In this embodiment, a typical electric motor arrangement is represented. The motor stator 208 includes a stack of laminations 210 on each side of the slot 206. The electrical current conducted through the heat source 214 (e.g., coils or the like) produces flux in the stack of laminations 210 that interact with the rotor resulting in torque on the rotor (not shown). To remove heat produced in the motor stator 208, a cooling tube 204 may be included and is electrically isolated from the stack of laminations 210 and the heat source 214. In various embodiments, the first portion 203 and the second portion 205 of the interface component 202 are disposed between an insulator 216 disposed on a heat source 214 and a top-stick 218. The top-stick 218 is a mechanical feature for retaining the various components in the slot 106 (e.g., the cooling tube 204, the first portion 203 and the second portion 205 of the interface components, etc.). According to some embodiments, there are grooves (not shown) in the stack of laminations 210 that corresponding grooves (not shown) of the top-stick 218 slide into during assembly. The high electrical resistivity of Boron-Nitride allows the cooling assembly to be placed in the slot 206 (e.g., such as a stator slot) with the heat source 214 without adding supplementary electrical insulating material. Supplementary electrical insulating material may reduce the overall thermal conductivity of the cooling system. Boron-Nitride is available in different grades and is easily machinable. This allows for different geometries of either slot width and/or tube sizes. Any length or number of slots may be used. The cooling tube 204 may be made of any material that is compatible with the cooling medium.

In various embodiments, the interface component 202 may be used in non-motor generator applications such as for stationary electromagnetic components. In particular, for transformers having back iron pieces that are kept cool, the interface component 202 may be applied to a cold plate and the transformer laminations to improve thermal conductivity.

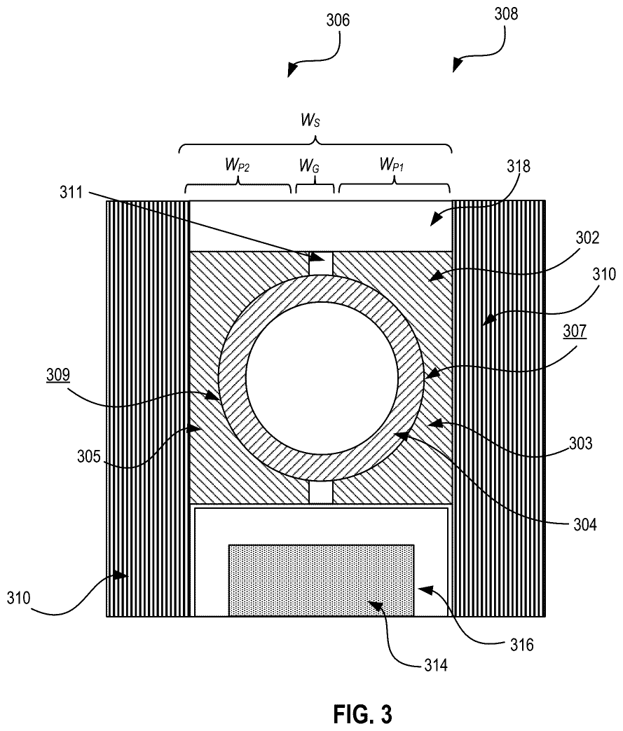

FIG. 3 illustrates a cross-section view of a motor stator 308 including an interface component 302 that is initially oversized, i.e., the sum of the widths of the first portion 303 and the second portion 305 are greater than the width of the slot 306, and then reduced in width, for example, sanded and lapped, to fit in the slot 306 in accordance with one embodiment of the present disclosure. According to various embodiments, the interface component 302 may include an electrically insulating and thermally conductive material such as Boron-Nitride, Silicon-Carbide, Boron-Carbide, diamond, or the like, or any combination thereof. In exemplary embodiments, the interface component 302 predominantly includes Boron-Nitride. FIG. 3 illustrates one application of the advanced interface material including Boron-Nitride. Boron-Nitride has favorable thermal conductivity to help expel heat from the motor stator. Boron-Nitride may be used at elevated temperatures, for example, less than or equal to 800° C.

According to various embodiments, the interface component 302 may include a plurality of portions or the interface component 302 may be a single unitary piece. The interface component 302 may include a first portion 303 and a second portion 305 where the first portion 303 and the second portion 305 are mirror images of one another. In various embodiments, the interface component 302 includes a plurality of portions such as at least three portions, at least four portions, etc. The first portion 303 may include a first interface 307 and the second portion 305 may include a second interface 309. The first interface 307 and the second interface 309 may be mirror images of one another, according to at least some embodiments. As shown in FIG. 3, the first interface 307 and the second interface 309 are curved such that the first interface 307 and the second interface 309 contact at least a portion of the cooling tube 304. For example, the first portion 303 has a width, W_{P1}, and the second portion 305 have a width, W_{P2}, and a gap 311 between the first portion 303 and the second portion 305 has a width, W_{G}. The gap 311 ensures that there is sufficient physical contact between the cooling tube 304 and the first portion 303 and the second portion 305 of the interface component 302. The gap 311 ensures that the interface component 302 is sufficiently wedged against the slot 306 to provide adequate thermal contact.

W_{P1} may be greater than, less than, or equal to W_{P2} according to various embodiments. A slot 306 of a motor stator 308 including the first portion 303 and the second portion 305 may be characterized as having a width, W_{S}.

In various embodiments, the interface component 302 and cooling tube 304 assembly may be oversized such that it creates an interference fit with the width, W_{S}, of the slot 306. At assembly, the interface component 302 may be sanded or lapped to create a tight fit into the slot 306. For example, W_{P1} and/or W_{P2} may be reduced such that W_{S}=W_{P1}+W_{P2}+W_{G}.

In some embodiments, the first interface 107 and the second interface 109 contact an entire exterior of the cooling tube 104 and the slot 106 has a width, W_{S}. Accordingly, W_{P1} and/or W_{P2} may be reduced such that W_{S}=W_{P1}+W_{P2}.

According to various embodiments, and as shown in FIG. 3, the first interface 307 and the second interface 309 are curved such that the first interface 107 and the second interface 309 contact at least a portion of the cooling tube 304. Cooling tubes as used throughout the present disclosure may include stainless steel. A cooling tube 304 may include electrically conductive materials such as Stainless Steel, Steel, Copper, Copper-Nickel, etc., or any combination thereof. In the embodiment illustrated in FIG. 3, cooling fluid flows into the plane of the figure and through the cooling tube 304.

In this embodiment, a typical electric motor arrangement is represented. The motor stator 308 includes a stack of laminations 310 on each side of the slot 306. The electrical current conducted through the heat source 314 (e.g., coils or the like) produces flux in the stack of laminations 310 that interact with the rotor resulting in torque on the rotor (not shown). To remove heat produced in the motor stator 308, a cooling tube 304 may be included and is electrically isolated from the stack of laminations 310 and the heat source 314. In various embodiments, the first portion 303 and the second portion 305 of the interface component 302 are disposed between an insulator 316 disposed on a heat source 314 and a top-stick 318. The top-stick 318 is a mechanical feature for retaining the various components in the slot 306 (e.g., the cooling tube 304, the first portion 303 and the second portion 305 of the interface components, etc.). According to some embodiments, there are grooves (not shown) in the stack of laminations 310 that corresponding grooves (not shown) of the top-stick 318 slide into during assembly. The high electrical resistivity of Boron-Nitride allows the cooling assembly to be placed in the slot 306 (e.g., such as a stator slot) with the heat source 314 without adding supplementary electrical insulating material. Supplementary electrical insulating material may reduce the overall thermal conductivity of the cooling system. Boron-Nitride is available in different grades and is easily machinable. This allows for different geometries of either slot width and/or tube sizes. Any length or number of slots may be used. The cooling tube 304 may be made of any material that is compatible with the cooling medium.

In various embodiments, the interface component 302 may be used in non-motor generator applications such as for stationary electromagnetic components. In particular, for transformers having back iron pieces that are kept cool, the interface component 302 may be applied to a cold plate and the transformer laminations to improve thermal conductivity.

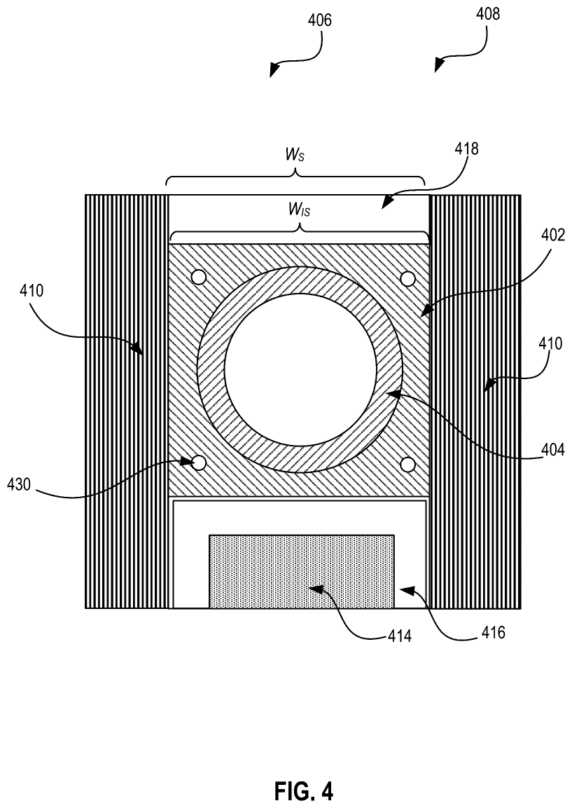

FIG. 4 illustrates a cross-section view of a motor stator 408 including an interface component 402 that is formed or deposited in place, in accordance with one embodiment of the present disclosure. The material of the interface component 402 may be formed or deposited using various advanced manufacturing techniques, such as additive manufacturing techniques, casting, hot pressing, sintering, or flame spray, or the like, to eliminate gaps between loose components and enhance minimize contact resistance between bodies. According to various embodiments, the interface component 402 may include an electrically insulating and thermally conductive material such as Boron-Nitride, Boron-Carbide, diamond, Silicon-Carbide, or the like, or any combination thereof. In exemplary embodiments, the interface component 402 predominantly includes Boron-Nitride. FIG. 4 illustrates one application of the advanced interface material including Boron-Nitride. Boron-Nitride has favorable thermal conductivity to help expel heat from the motor stator. Boron-Nitride may be used at elevated temperatures, for example, less than or equal to 800° C.

According to various embodiments, the interface component 402 may be deposited in the slot 406 as a single unitary piece. As shown in FIG. 4, the interface component 402 is disposed such that the interface component 402 encapsulates a cooling tube 404 within the slot 406. Cooling tubes as used throughout the present disclosure may include stainless steel. A cooling tube 304 may include electrically conductive materials such as Stainless Steel, Steel, Copper, Copper-Nickel, etc., or any combination thereof. In the embodiment illustrated in FIG. 4, cooling fluid flows into the plane of the figure and through the cooling tube 404. In at least some embodiments, the slot 406 of a motor stator 408 may be characterized as having a width, W_{S}, that is equal to the width, W_{IS}, of the interface component 402.

In this embodiment, a typical electric motor arrangement is represented. The motor stator 408 includes a stack of laminations 410 on each side of the slot 406. The electrical current conducted through the heat source 414 (e.g., coils or the like) produces flux in the stack of laminations 410 that interact with the rotor resulting in torque on the rotor (not shown). To remove heat produced in the motor stator 408, a cooling tube 404 may be included and is electrically isolated from the stack of laminations 410 and the heat source 414. In various embodiments, the interface component 402 is disposed between an insulator 416 disposed on a heat source 414 and top-stick 418. The top-stick 418 is a mechanical feature for retaining the various components in the slot 406 (e.g., the cooling tube 404 and the interface component 402, etc.). According to some embodiments, there are grooves (not shown) in the stack of laminations 410 that corresponding grooves (not shown) of the top-stick 418 slide into during assembly. The high electrical resistivity of Boron-Nitride allows the cooling assembly to be placed in the slot 406 (e.g., such as a stator slot) with the heat source 414 without adding supplementary electrical insulating material. Supplementary electrical insulating material may reduce the overall thermal conductivity of the cooling system. Boron-Nitride is available in different grades and is easily machinable. This allows for different geometries of either slot width and/or tube sizes. Any length or number of slots may be used. The cooling tube 404 may be made of any material that is compatible with the cooling medium.

In various embodiments, the interface component 402 (e.g., the non-homogenous, composite crystalline or metallic (e.g., Boron-nitride) component) is reinforced with embedded fibers or rods 430 to enhance mechanical strength and reduce brittleness. For example, according to various embodiments, the interface component 402 may include one or more ceramics that are relatively brittle and that may be reinforced with rods, fibers, or the like.

In various embodiments, the interface component 402 may be used in non-motor generator applications such as for stationary electromagnetic components. In particular, for transformers having back iron pieces that are kept cool, the interface component 402 may be applied to a cold plate and the transformer laminations to improve thermal conductivity.

According to various embodiments, an electric machine includes a “Slotless” or “Semi-Slotless” arrangement and cooling tubes placed in the stator. The cooling tubes are electrically isolated from the electrical conducting coils and the magnetically permeable lamination stack using a material with high thermal conductivity relative to conventional electrical insulating materials and that act as an electrical insulator (e.g., Boron-Nitride, Boron-Carbide, diamond, Silicon Caribe, or the like). In this embodiment, an interface component arrangement of the electrically isolating material surrounds cooling tube(s) that are made from electrically conductive materials (e.g., Stainless Steel, Steel, Copper, Copper-Nickel, or the like) and provides a thermal conduction path that is greater than conventional electric machine insulating materials (e.g., MICA, Polyimide, Nomex, or the like).

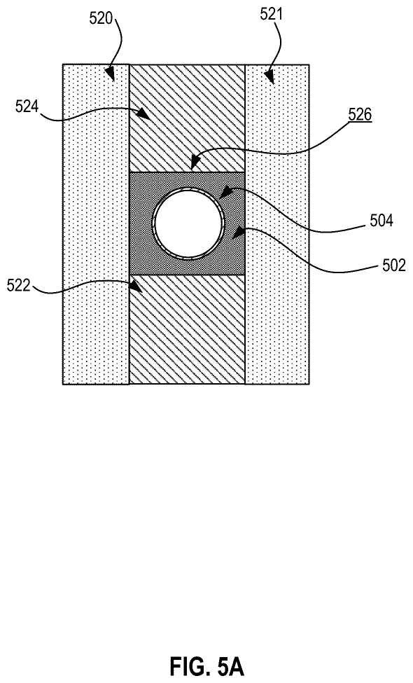

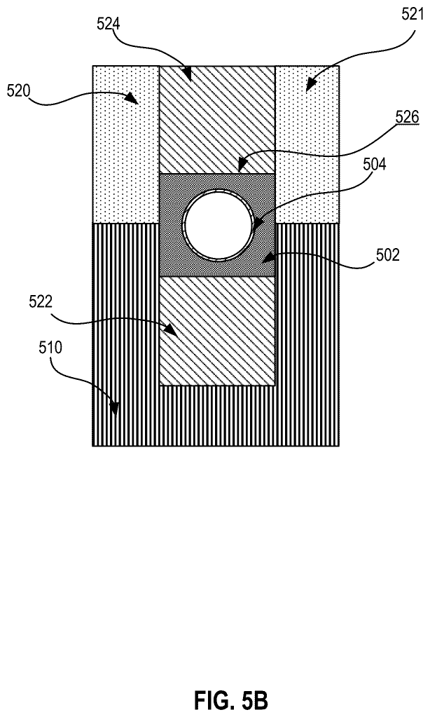

FIGS. 5A-5B illustrate both a “slotless” arrangement without laminations and a “semi-slotless” arrangement with a partially laminated structure in accordance with various embodiments of the present disclosure. As discussed more fully below, various embodiments of the present disclosure do not include magnetically permeable materials, laminations or laminated magnetic alloy structures. Other embodiments may include “slotless” or “semi-slotless” electromagnetic arrangements as discussed in relation to FIGS. 5A and 5B. Various embodiments of the present disclosure may be applied to machines including stator slots. In other embodiments, the slots are removed and replaced with a material that is non-magnetic. According to various embodiments, the enhanced cooling systems as described herein may be further applied to electromagnetic topologies.

FIG. 5A illustrates a “slotless” arrangement without laminations in accordance with various embodiments of the present disclosure. As illustrated in FIG. 5A, a “slotless” electromagnetic arrangement does not include a stack of laminations 510. Accordingly, at least some embodiments of the present disclosure may be applied to non-slotted machines such as holdback machines and other slotless machines.

Referring to FIG. 5A, the interface component 502 is formed around a cooling tube 504. In various embodiments, the interface component 102 surrounding the cooling tube 504 may be used to reject heat along the length (i.e., the intermediate portion 150 shown in FIG. 1B) of the cooling tube 504. The material of the interface component 502 may be formed or deposited using various advanced manufacturing techniques, such as additive manufacturing techniques, casting, hot pressing, sintering, or flame spray, or the like, to eliminate gaps between loose components and enhance minimize contact resistance between bodies. According to various embodiments, the interface component 502 may include an electrically insulating and thermally conductive material such as Boron-Nitride, Boron-Carbide, diamond, Silicon-Carbide, or the like, or any combination thereof. In exemplary embodiments, the interface component 502 predominantly includes Boron-Nitride. FIG. 5A illustrates one application of the advanced interface material including Boron-Nitride. Boron-Nitride has favorable thermal conductivity to help expel heat from the motor stator. Boron-Nitride may be used at elevated temperatures, for example, less than or equal to 800° C.

According to various embodiments, slotless arrangements include that the interface component 502 may be deposited in between a first portion of non-laminated, low-magnetic permeable material 520 and a second portion of non-laminated, low-magnetic permeable material 521 as a single unitary piece. Furthermore, the interface component 502 may be further deposited on top of a first electrical conductor 522. A second electrical conductor 524 may be disposed on top of the interface component 502. The first electrical conductor 522 may include the same material as the second electrical conductor 524 or the first electrical conductor 522 may include different materials than the second electrical conductor 524. In exemplary embodiments, and as illustrated in FIG. 5A, the interface component 502 is surrounded on each side 526 of the interface component 502.

As shown in FIG. 5A, the interface component 502 is disposed such that the interface component 502 encapsulates a cooling tube 504. Cooling tubes as used throughout the present disclosure may include stainless steel. A cooling tube 504 may include electrically conductive materials such as Stainless Steel, Steel, Copper, Copper-Nickel, etc., or any combination thereof. In the embodiment illustrated in FIG. 5A, cooling fluid flows into the plane of the figure and through the cooling tube 504.

FIG. 5B illustrates a “semi-slotless” arrangement with a partially laminated structure in accordance with various embodiments of the present disclosure. As shown in FIG. 5B, the “semi-slotless” electromagnetic arrangement includes a stack of laminations 110 at least partially in contact with the interface component 502.

Referring to FIG. 5B, the interface component 502 is formed around a cooling tube 504. In various embodiments, the interface component 102 surrounding the cooling tube 504 may be used to reject heat along the length of the cooling tube 504. The material of the interface component 502 may be formed or deposited using various advanced manufacturing techniques, such as additive manufacturing techniques, casting, hot pressing, sintering, or flame spray, or the like, to eliminate gaps between loose components and enhance minimize contact resistance between bodies. According to various embodiments, the interface component 502 may include an electrically insulating and thermally conductive material such as Boron-Nitride, Boron-Carbide, diamond, Silicon-Carbide, or the like, or any combination thereof. In exemplary embodiments, the interface component 502 predominantly includes Boron-Nitride. FIG. 5B illustrates one application of the advanced interface material including Boron-Nitride. Boron-Nitride has favorable thermal conductivity to help expel heat from the motor stator. Boron-Nitride may be used at elevated temperatures, for example, less than or equal to 800° C.

According to various embodiments, semi-slotless arrangements include that the interface component 502 may be deposited in between a first portion of non-laminated, low-magnetic permeable material 520 and a second portion of non-laminated, low-magnetic permeable material 521 as a single unitary piece. In this embodiment, the stack of laminations 110 may share a side 526 of the interface component 502. For example, the stack of laminations 110 may form contact a portion of the side and the first portion of non-laminated, low-magnetic permeable material 520 or the second portion of non-laminated, low-magnetic permeable material 521 may contact the another portion of the same side.

Furthermore, the interface component 502 may be further deposited on top of a first electrical conductor 522. A second electrical conductor 524 may be disposed on top of the interface component 502. The first electrical conductor 522 may include the same material as the second electrical conductor 524 or the first electrical conductor 522 may include different materials than the second electrical conductor 524. In exemplary embodiments, and as illustrated in FIG. 5B, the interface component 502 is surrounded on each side 526 of the interface component 502.

As shown in FIG. 5B, the interface component 502 is disposed such that the interface component 502 encapsulates a cooling tube 504. Cooling tubes as used throughout the present disclosure may include stainless steel. A cooling tube 504 may include electrically conductive materials such as Stainless Steel, Steel, Copper, Copper-Nickel, etc., or any combination thereof. In the embodiment illustrated in FIG. 5B, cooling fluid flows into the plane of the figure and through the cooling tube 504.

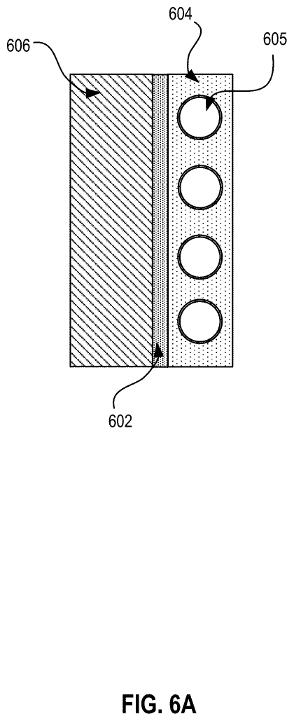

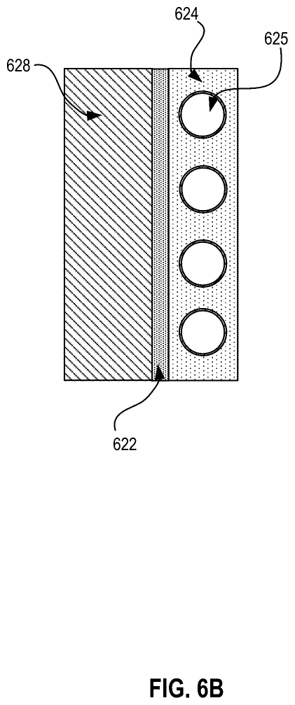

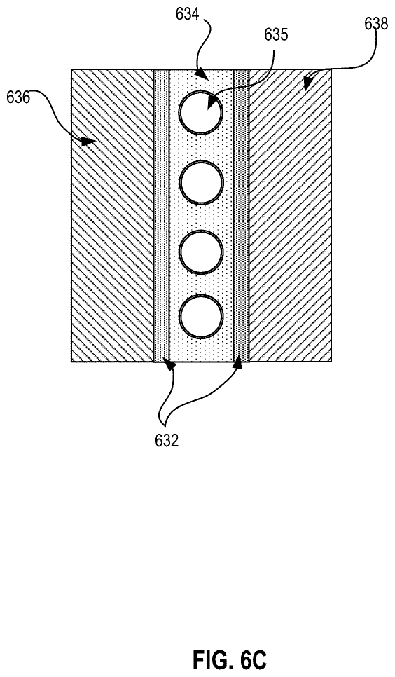

FIG. 6A illustrates a cross-section view of an interface component 602 applied between a cold plate 604 and electrical conductors in accordance with various embodiments of the present disclosure. As illustrated in FIG. 6A, the interface component 602 (such as interface component 502 shown in FIG. 5A) may be applied between the cold plate 604 and various other components for providing enhanced cooling effects. The cold plate 604 may define one or more fluid passages 605. In the illustrated embodiment, the interface component 602 is applied between a cold plate 604 and an electrically conductive winding 606. The interface component 602 can include a crystalline or metallic material (e.g., such as Boron-Nitride).

The interface component 602 may be applied to the cold plate 604 directly using advanced manufacturing techniques such as flame spray or additive manufacturing, or individual pieces of interface component 602 may be applied at the interface points (e.g., between the cold plate 604 and the electrically conductive winding 606).

FIG. 6B illustrates a cross-section view of an interface component 622 applied between a cold plate 624 and a magnetically permeable core 628 in accordance with various embodiments of the present disclosure. As illustrated in FIG. 6B, the interface component 622 (such as interface component 502 illustrated in FIG. 5A) may be applied between the cold plate 624 and various other components for providing enhanced cooling effects. The cold plate 624 may define one or more fluid passages 625. In the illustrated embodiment, the interface component 622 is applied between a cold plate 624 and the magnetically permeable core 628.

In some embodiments, the interface component 622 includes a crystalline or metallic material (e.g., such as Boron-Nitride) applied between the cold plate 624 and the magnetically permeable core 628. The interface component 622 may be applied to the cold plate 624 directly using advanced manufacturing techniques such as flame spray or additive manufacturing, or individual pieces of interface component 622 may be applied at the interface points (e.g., between the cold plate 604 and magnetically permeable cores 628).

FIG. 6C illustrates a cross-section view of a interface component 632 applied between a cold plate 634 and electrical conductors and between the cold plate 634 and a magnetically permeable core 638 in accordance with various embodiments of the present disclosure. As illustrated in FIG. 6C, the interface component 622 is applied between both the cold plate 634 and the electrical conductors and between the cold plate 634 and the magnetically permeable core 638. Referring to FIG. 6C, the interface component 632 (such as interface component 502 illustrated in FIG. 5A) may be applied between the cold plate 634 and various other components for providing enhanced cooling effects. The cold plate 634 may define one or more fluid passages 635. In the illustrated embodiment, the interface component 632 is applied between the cold plate 634 and the electrically conductive winding 636 as well as between the cold plate 634 and the magnetically permeable core 638. The interface component 632 can include a crystalline or metallic material (e.g., such as Boron-Nitride) applied between the cold plate 634 and the electrically conductive winding 636 and between the cold plate 634 and the magnetically permeable core 638.

The interface component 632 may be applied to the cold plate 634 directly using advanced manufacturing techniques such as flame spray or additive manufacturing, or individual pieces of interface component 632 may be applied at the interface points (e.g., between the cold plate 634 and the electrically conductive winding 636 and/or between the cold plate 634 and the magnetically permeable core 638).

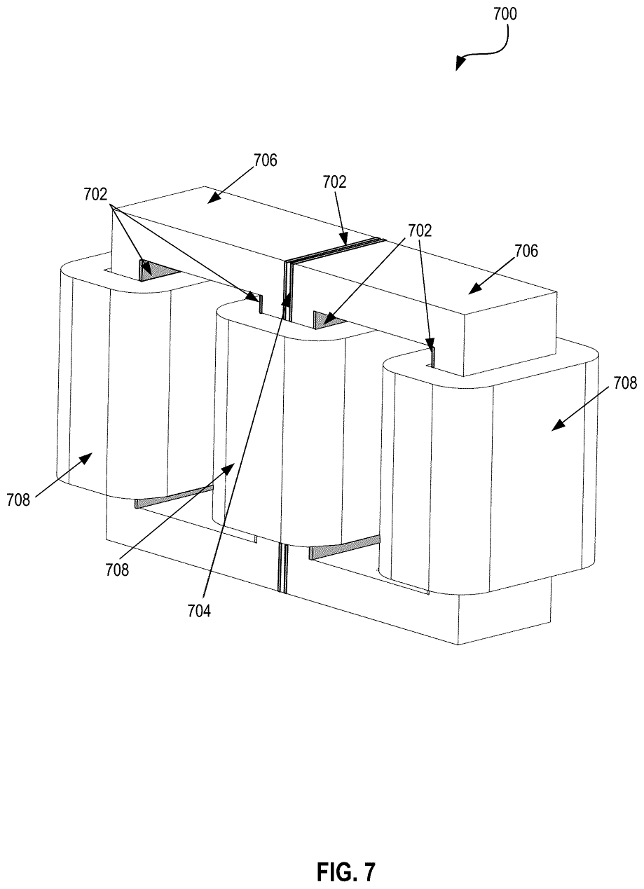

FIG. 7 illustrates an exemplary application of the enhanced cooling embodiments described herein in accordance with various embodiments of the present disclosure. According to various embodiments, the interface component 702 may include an electrically insulating and thermally conductive material such as Boron-Nitride, Boron-Carbide, diamond, Silicon-Carbide, or the like, or any combination thereof. In exemplary embodiments, the interface component 702 predominantly includes Boron-Nitride. FIG. 7 illustrates one application of the advanced interface material including Boron-Nitride. Boron-Nitride has favorable thermal conductivity to help expel heat from the motor stator. Boron-Nitride may be used at elevated temperatures, for example, less than or equal to 800° C.

A system 700 may include an interface component 702 disposed between a cold plate 704 and a transformer core 706 having a transformer coil 708 disposed around the transformer core 706. In various embodiments, the cold plate 704 may be disposed between two interface components as shown in the figure. As further shown, an interface component 702 may be disposed between a transformer coil 708 and a transformer core 706. Accordingly, the interface component 702 may be applied at any interface between two components for electrically insulating and increasing the thermal conductivity of the system 700.

In power dense transformers, liquid cooled cold plates may be embedded between laminated core sections and/or between electrical winding sets to improve thermal performance. In these cases, an electrical insulator is normally placed between the cold plate and the core and or between the cold plate and the electrical winding to prevent shorting of the individual laminations or shorting of the electrical windings to the grounded cold plate. The electrical insulators typically used at these interfaces are poor thermal conductors and negatively impact the thermal conductivity of the cooling circuit. Another application of the embodiments described herein may include replacing the electrical insulator that is used between a transformer core cold plate and segmented laminated core sections and/or between embedded cold plates between transformer windings with an advanced material like Boron-Nitride. The Boron-Nitride material electrically insulates while greatly increasing the thermal conductivity of the cooling system circuit.

According to at least one embodiment, an electric machine's cooling tubes are placed in the stator slots and are electrically isolated from the electrical conducting coils and the magnetically permeable lamination stack using a material with high thermal conductivity relative to conventional electrical insulating materials and act as an electrical insulator (e.g., Boron-Nitride, Boron-Carbide, diamond, Silicon Caribe, or the like). In this embodiment, an interface component arrangement of the electrically isolating material surrounds cooling tube(s) that are made from electrically conductive materials (e.g., Stainless Steel, Steel, Copper, Copper-Nickel, or the like) and provides a thermal conduction path that is greater than conventional electric machine insulating materials (e.g., MICA, Polyimide, Nomex, or the like).

According to another embodiment, an electric machine (motor or generator) includes a stator including cooling tubes for removal of waste heat and the cooling tubes are electrically isolated from the coil conductors and/or magnetically permeable lamination stack using material(s) that provide high thermal conductivity relative to conventional electrical insulating materials and act as an electrical insulator. In this embodiment, an interface component arrangement is used to surround cooling tube(s) that are made from electrically conductive materials (Stainless Steel, Steel, Copper, Copper-Nickel, or the like).

According to another embodiment, an electric machine (motor or generator) includes a rotor including cooling tubes for removal or waste heat and the cooling tubes are electrically isolated from the coil conductors and/or magnetically permeable lamination stack using material(s) that provide high thermal conductivity relative to conventional electrical insulating materials and act as an electrical insulator. In this embodiment, an interface component arrangement is used to surround cooling tube(s) that are made from electrically conductive materials (e.g., Stainless Steel, Steel, Copper, Copper-Nickel, or the like).

According to another embodiment, an electric component (e.g., a transformer, an inductor, or other filter components) including electrical windings and a magnetically permeable core further including cooling tubes for removal of waste heat and the cooling tubes are electrically isolated from the coil conductors and/or magnetically permeable core using material(s) that provide high thermal conductivity relative to conventional electrical insulating materials and act as an electrical insulator. In this embodiment, an interface component arrangement is used to surround cooling tube(s) that are made from electrically conductive materials (e.g., Stainless Steel, Steel, Copper, Copper-Nickel, or the like).

Various embodiments of the present disclosure may be used in applications such as marine or aerospace propulsion motors, marine or aerospace power generators, marine or aerospace auxiliary motors, marine or aerospace power conversion inductors, marine or aerospace propulsion motor drive transformers and filters, or the like. In some embodiments, the encapsulated cooling tubes described herein may be used in submarine applications.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is an apparatus including a cooling tube including a proximal end having a first opening and a distal end having a second opening. The cooling tube includes an intermediate portion extending between the proximal end and the distal end. The apparatus includes an interface component disposed on an exterior interface of the intermediate portion and at least partially encapsulating the cooling tube, the interface component composed of an electrically insulating and thermally conductive material. The interface component is in abutting contact with one or more heat conducting or heat generating elements of an electromechanical device.

Example 2 is the apparatus of example 1, wherein the interface component comprises a first portion and a second portion.

Example 3 is the apparatus of example(s) 1-2, wherein the first portion further comprises a first interface and the second portion further comprises a second interface, wherein the first interface and the second interface are in contact with the cooling tube.

Example 4 is the apparatus of example(s) 1-3, wherein the first portion and the second portion are mirror images of each other.

Example 5 is the apparatus of example(s) 1-4, wherein a width of the first portion is less than or equal to a width of the second portion.

Example 6 is the apparatus of example(s) 1-5, wherein the electrically insulating and thermally conductive material comprises Boron-Nitride.

Example 7 is the apparatus of example(s) 1-6, wherein the electrically insulating and thermally conductive material comprises Silicon-Carbide.

Example 8 is the apparatus of example(s) 1-7, wherein the electrically insulating and thermally conductive material comprises a non-homogeneous composite, crystalline, or metallic material.

Example 9 is the apparatus of example(s) 1-8, wherein the electrically insulating and thermally conductive material comprises Boron-Carbide.

Example 10 is the apparatus of example(s) 1-9, wherein the electrically insulating and thermally conductive material comprises diamond.

Example 11 is the apparatus of example(s) 1-10, further including embedded fibers or rods disposed within the electrically insulating and thermally conductive material.

Example 12 is a system including a stator having a plurality of slots, a heat source abutting at least one of the plurality of slots, and a cooling tube disposed within each of the plurality of slots. The cooling tube is encapsulated by an electrically insulating and thermally conductive material disposed between the cooling tube and the each of the slots.

Example 13 is the system of example(s) 12, wherein the electrically insulating and thermally conductive material comprises Boron-Nitride.

Example 14 is the system of example(s) 12-13, wherein the electrically insulating and thermally conductive material comprises Silicon-Carbide.

Example 15 is the system of example(s) 12-14, wherein the electrically insulating and thermally conductive material comprises Boron-Carbide.

Example 16 is the system of example(s) 12-15, wherein the electrically insulating and thermally conductive material comprises diamond.

Example 17 is a system including a rotor having a plurality of slots, a heat source abutting at least one of the plurality of slots, and a cooling tube disposed within each of the plurality of slots. The cooling tube is encapsulated by an electrically insulating and thermally conductive material forming an interface between the cooling tube and each of the slots.

Example 18 is the system of example(s) 17, herein the electrically insulating and thermally conductive material comprises Boron-Nitride.

Example 19 is the system of example(s) 17-18, wherein the electrically insulating and thermally conductive material comprises Silicon-Carbide.

Example 20 is the system of example(s) 17-19, wherein the electrically insulating and thermally conductive material comprises Boron-Carbide.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

The technology described and claimed herein is not to be limited in scope by the specific preferred embodiments herein disclosed, since these embodiments are intended as illustrations, and not limitations, of several aspects of the technology. Any equivalent embodiments are intended to be within the scope of this technology. Indeed, various modifications of the technology in addition to those shown and described herein will become apparent to those skilled in the art from the foregoing description. Such modifications are also intended to fall within the scope of the appended claims.

What is claimed is:

1. An apparatus comprising:
a cooling tube including a proximal end having a first opening and a distal end having a second opening, wherein the cooling tube includes an intermediate portion extending between the proximal end and the distal end; and
an interface component disposed on an exterior interface of the intermediate portion and at least partially encapsulating the cooling tube, the interface component composed of an electrically insulating and thermally conductive material, wherein the interface component is in abutting contact with one or more heat conducting or heat generating elements of an electromechanical device.

2. The apparatus of claim 1, wherein the interface component comprises a first portion and a second portion.

3. The apparatus of claim 2, wherein the first portion further comprises a first interface and the second portion further comprises a second interface, wherein the first interface and the second interface are in contact with the cooling tube.

4. The apparatus of claim 2, wherein the first portion and the second portion are mirror images of each other.

5. The apparatus of claim 2, wherein a width of the first portion is less than or equal to a width of the second portion.

6. The apparatus of claim 1, wherein the electrically insulating and thermally conductive material comprises Boron-Nitride.

7. The apparatus of claim 1, wherein the electrically insulating and thermally conductive material comprises Silicon-Carbide.

8. The apparatus of claim 1, wherein the electrically insulating and thermally conductive material comprises a non-homogeneous composite, crystalline, or metallic material.

9. The apparatus of claim 1, wherein the electrically insulating and thermally conductive material comprises Boron-Carbide.

10. The apparatus of claim 1, wherein the electrically insulating and thermally conductive material comprises diamond.

11. The apparatus of claim 1, further comprising embedded fibers or rods disposed within the electrically insulating and thermally conductive material.

12. A system comprising:
a stator having a plurality of slots,
a heat source abutting at least one of the plurality of slots; and
a cooling tube disposed within each of the plurality of slots,
wherein the cooling tube is encapsulated by an electrically insulating and thermally conductive material disposed between the cooling tube and the each of the slots.

13. The system of claim 12, wherein the electrically insulating and thermally conductive material comprises Boron-Nitride.

14. The system of claim 12, wherein the electrically insulating and thermally conductive material comprises Silicon-Carbide.

15. The system of claim 12, wherein the electrically insulating and thermally conductive material comprises Boron-Carbide.

16. The system of claim 12, wherein the electrically insulating and thermally conductive material comprises diamond.

17. A system comprising:
a rotor having a plurality of slots;
a heat source abutting at least one of the plurality of slots; and
a cooling tube disposed within each of the plurality of slots,
wherein the cooling tube is encapsulated by an electrically insulating and thermally conductive material forming an interface between the cooling tube and each of the slots.

18. The system of claim 17, herein the electrically insulating and thermally conductive material comprises Boron-Nitride.

19. The system of claim 17, wherein the electrically insulating and thermally conductive material comprises Silicon-Carbide.

20. The system of claim 17, wherein the electrically insulating and thermally conductive material comprises Boron-Carbide.
